(19) United States
(12) Patent Application Publication
(10) Pub. No.: US 2018/0168899 A1
(43) Pub. Date: Jun. 21, 2018

(54) PATIENT BED WITH SUPPORT ASSIST

(71) Applicant: Hill-Rom Services, Inc., Batesville, IN (US)

(72) Inventors: David C. Newkirk, Lawrenceburg, IN (US); Jack B. Sing, Batesville, IN (US); Kirsten M. Emmons, Batesville, IN (US)

(21) Appl. No.: 15/831,748

(22) Filed: Dec. 5, 2017

Related U.S. Application Data
(60) Provisional application No. 62/434,522, filed on Dec. 15, 2016.

(51) Int. Cl. A61G 7/00; A61G 7/05; A61G 7/018

(52) U.S. Cl. CPC A61G 7/001; A61G 7/0507; A61G 7/012; A61G 7/0506; A61G 7/018

(57) ABSTRACT

Devices, systems, and methods for supporting patients may include a support top and a positioning arm for assisting positioning of a patient's body.

The present disclosure claims the benefit, under 35 U.S.C. § 119(e), of U.S. Provisional Application No. 62/434,522, which was filed Dec. 15, 2016, and which is hereby incorporated by reference herein in its entirety.

### BACKGROUND

The present disclosure relates to devices, systems, and methods for supporting patients. More specifically, the present disclosure relates to devices, systems, and methods for supporting patients' bodies in various positions.

Patient supports can assist caregivers in providing care to patients of care facilities. Care facilities, for example, hospitals, may provide care to many patients and, thus, may be required to meet a wide variety of care requirements. Adaptability of patient supports can increase comfort for patients, encourage continuity in operation, encourage accommodation of various patient needs, and increase caregivers' ease and extent of access to areas of patients' bodies. Such adaptability can assist in meeting the variety of care requirements that care facilities may encounter in providing care for patients.

### SUMMARY

The present application discloses one or more of the features recited in the appended claims and/or the following features which, alone or in any combination, may comprise patentable subject matter:

According to an aspect of the present disclosure, a patient support system may include a support top including a platform and a support surface positioned on a top side of the platform, a support frame coupled to the support top, the support frame including a number of support columns extending vertically for connection with the support top, and at least one positioning arm for assisting movement of a patient's body occupying the support top, the at least one positioning arm extending from one of the number of support columns to an operation end located above the support top. The at least one positioning arm may be pivotable about the one of the number of support columns for positioning the operation end relative to the patient's body.

In some embodiments, the at least one positioning arm may include a collar extending at least partially circumferentially about the one of the number of support columns.

In some embodiments, the at least one positioning arm may include a branch extending from the one of the number of support columns to an end that is spaced apart laterally from an edge of the support top and may include a riser projecting upward from the branch to an end that is above the support top.

In some embodiments, the at least one positioning arm may include a limb extending from the riser to form the operation end. In some embodiments, the branch and the limb may extend parallel to each other.

In some embodiments, the support frame may include a base for engagement with the floor and the number of support columns may extend vertically from the base for connection with the support top.

In some embodiments, the number of support columns may connect with a bottom side of the platform.

In some embodiments, the support top may include at least one attachment rail arranged on a lateral side of the support top. In some embodiments, the at least one attachment rail may include a rail body extending between head and foot ends of the support top and attached to the platform for receiving connection of auxiliaries.

In some embodiments, the patient support system may include a number of limb support boards and may include a number of siderails. In some embodiments, each of the number of limb support boards and the number of siderails may be configured for selective removable attachment to the rail body of the attachment rail.

In some embodiments, the number of siderails may be attached to the rail body and may be adapted for selective articulation between a raised position in which a siderail body is arranged above the support top and a lowered position in which the siderail body is arranged below the support top.

According to another aspect of the present disclosure, a patient support system may include a support device including a support top having a support surface and a platform having at least one attachment rail, and at least one support column for supporting the support top above the floor, a positioning system including at least one positioning arm extending from the support device and adapted to assist positioning a patient's body occupying the support top, and an auxiliary attachment suite for removable attachment to the support device. The auxiliary attachment suite may include a number of siderails and a number of attachment devices each configured for removable attachment with the at least one attachment rail of the platform.

In some embodiments, the at least one positioning arm may extend from one of the number of support columns to an operation end located above the support top. In some embodiments, the at least one positioning arm may include a collar extending at least partially circumferentially about the at least one support column.

In some embodiments, the at least one positioning arm may include a branch extending from the one of the number of support columns to an end that is spaced apart laterally from an edge of the support top, a riser projecting upward from the branch to an end that is above the support top, and a limb extending from the riser to form the operation end.

In some embodiments, the at least one attachment rail may be arranged on a side of the support top. In some embodiments, the at least one attachment rail includes a rail body extending between head and foot ends of the support top and attached to the platform for receiving selective connection with the auxiliary attachment suite.

In some embodiments, the number of siderails may each be removably attached to the rail body and adapted for selective articulation between a raised position in which a siderail body is arranged above the support top to inhibit the patient's body from exiting the support top and a lowered position in which the siderail body is arranged below the support top.

In some embodiments, the number of side rails may each include an attachment clamp for removable attachment to the at least one attachment rail.

In some embodiments, the attachment clamp including a clamp body and at least one arm pivotably attached to the body.

In some embodiments, the at least one attachment rail may include two attachment rails attached to one side of the support platform, and the number of side rails each include an attachment clamp including a clamp body and at least one arm extending from the body for engagement with one of the two attachment rails and at least one other arm extending from the body for engagement with another of the two attachment rails.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a patient support system including a support top having a support platform and a support surface mounted on the support platform to support a patient occupying the support top, and showing that the support top is supported above the floor by a support frame including support columns, and showing that the patient support system includes a positioning system for assistance in positioning a patient's body;

FIG. 2 is a perspective view of the patient support system of FIG. 1 showing that the positioning system includes positioning arms each having a positioning end arranged above the support top for assistance in positioning a patient's body;

FIG. 3 is a perspective view of the patient support system of FIGS. 1 and 2 showing that the positioning arms have been pivoted around the support columns for arrangement on the same lateral side of the support platform to assist in rotating the patient's body;

FIG. 4 is a perspective view of the patient support system of FIGS. 1-3 showing that a surgical base can selectively replace the support frame to support the support top above the floor;

FIG. 5 is a perspective view of the patient support system of FIGS. 1-4 during a transition between the support frame and the surgical base;

FIG. 6 is a perspective view of the patient support system of FIGS. 1-5 during a transition between the support frame and the surgical base, showing that the surgical base is connected to the underside of the support platform;

FIG. 7 is a perspective view of the patient support system of FIGS. 1-6 showing that the support frame is disconnected from the support platform;

FIG. 8 is a perspective view of the patient support system of FIGS. 1-7 showing that attachments, embodied as side rails, are removably attachable to the support top by an attachment assembly including attachment rails;

FIG. 9 is a perspective view of the patient support system of FIGS. 1-8 showing that another attachment, embodied as a limb support board, is removably attached to the support top by the attachment rails;

FIG. 10 is a perspective view of an attachment clamp of an attachment secured with the support top;

FIG. 11 is a cross-sectional view of the attachment clamp of FIG. 10 of an attachment secured with the support top showing that the attachment clamp deifnes a slot for receiving the attachment rail and includes a tensioner for selective engagement with the attachment rail to releasbly lock the attachment clamp in position;

FIG. 12 is a perspective view of another embodiment of an attachment assembly including an attachment clamp of an attachment (side rail) having a pair of slots for receiving a pair of attachment rails;

FIG. 13 is an elevation view of the attachment assembly of FIG. 12 showing that the pair of attachment rails includes an upper and lower rail body;

FIG. 14 is a cross-sectional view of the attachment assembly of FIGS. 12 and 13 showing that attachment clamp includes a body and a number of arms extending to form the slots for receiving the rail bodies, and showing that one arm (lower arm) is pivotably attached to the clamp body by a hinge to assist in connecting the attachment clamp with the platform; and

FIG. 15 is a perspective view of the patient support assembly of FIG. 8 having another attachment assembly for securing the side rails to a receiver arranged on the underside of the support platform.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

Appropriately handling and positioning patients' bodies can increase patient comfort, combat ailments, and provide proper access for caregivers. Patient supports that can assist in such proper handling and positioning can reduce impediments to appropriate caregiving. For example, patient supports that can support customizable configurations to support specific body positions can accommodate various patient body types and/or care requirements, among other advantages.

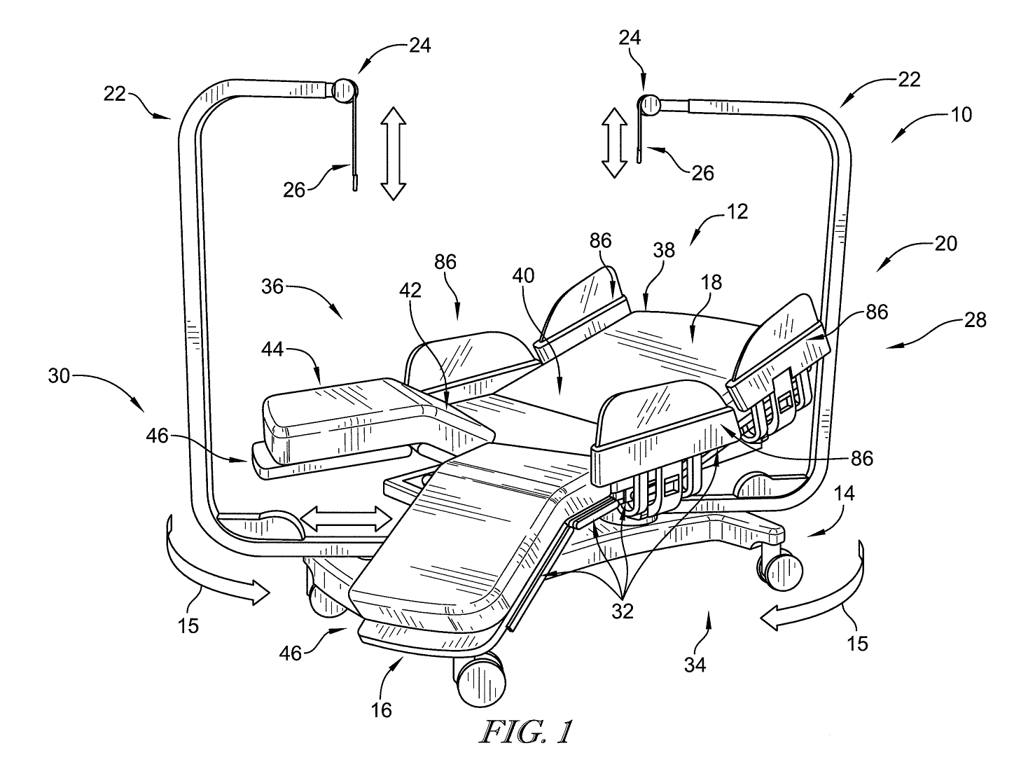

In the illustrative embodiment shown in FIG. 1, a patient support system 10 illustratively includes a support top 12 and a frame 14 supporting the support top 12 above the floor. The support top 12 illustratively includes a platform 16 and a support surface 18, embodied as a mattress, that is supported on a top side of the platform 16. The patient support system 10 illustratively includes a position assist (positioning) system, or, positioning system 20, for assisting positioning of a patient's body.

As shown in FIG. 1, the positioning system 20 illustratively includes a pair of positioning arms 22 each having an end 24 that is positionable above the patient support 12 to assist in positioning the patient's body. Each positioning arm 22 illustratively includes a winch cable 26 that extends from the respective end 24 to engage the patient's body. As discussed below, the winch cable 26 can be selectively operated between extended and retracted positions to assist positioning of the patient's body. In the illustrative embodiment, positioning the patient's body includes multi-purpose manipulation of the patient's body, for example but without limitation, for limb and/or body positioning, transfer between patient supports, turning, traction, therapy, among other manipulations.

As shown in FIG. 1, the support top 12 illustratively extends between a head end 28 and foot end 30 and defines lateral sides 34, 36. The support top illustratively includes attachment rails 32 secured to each lateral side 34, 36 of the support top 12. The attachment rails 32 are illustratively secured to the platform 16 at the lateral sides 34, 36. The attachment rails 32 provide a common receiver to receive selective attachment of various features as discussed in additional detail below.

As shown in FIG. 1, the support top 12 illustratively includes articulating support sections 38, 40, 42, 44. The support sections 38, 40, 42, 44 illustratively includes a head section 38, a lumbar section 40, a pelvic section 42, and a foot section 44 each corresponding generally with respective body areas of a patient while occupying the support top 12. Each support section 38, 40, 42, 44 is embodied to be articulable into various support positions (e.g., partially dropped leg-raised head and lumbar position as shown FIG. 1). In the illustrative embodiment, the pelvic and foot sections 42, 44 comprise split sections 46 arranged for separate arrangement to provide customized positioning.

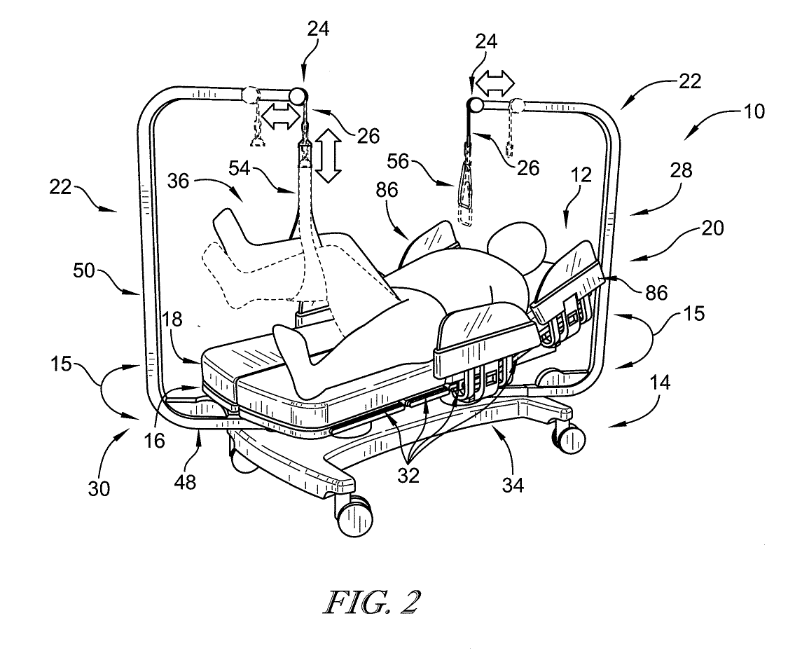

In the illustrative embodiment as shown in FIG. 2, the positioning system 20 assists handling and/or positioning of the patient's body. The positioning arms 22 illustratively connect with the frame 14 beneath the support top 12. The positioning arm 22 are each illustratively arranged to pivot about the frame 14 as indicated by arrows 15 to position the ends 24 appropriately above the support top 12 according to the manner of manipulation to be applied to the patient's body.

As shown in FIG. 2, the positioning arms 22 each illustratively include a branch 48 engaged with the frame 14 and extending outward from beneath the support top 12, a riser 50 projecting upward from the branch 48, and a limb 52 extending inward from the riser 50 to form the end 24. The positioning arms 22 each illustratively form a C-shape to position the end 24 above the support top 12.

As shown in FIG. 2, the limbs 52 are each illustratively embodied as telescoping arms that are movable between an extended position (as shown in solid line in FIG. 2) and a retracted position (as shown in broken line in FIG. 2) to determine the extent of the reach of the end 24 over the support top 12. The branches 48 are also embodied as telescoping members to increase the range of moveable extension of the end 24. In the illustrative embodiment, the telescoping members are embodied to be powered by actuators for movement between the extended and retracted positions. In some embodiments, either of the limbs 52 or branches 48 may be fixed in length with the other adapted for extension and retraction to position the ends 24.

As shown in FIG. 2, each winch cable 26 is illustratively operable between a retracted position (as shown in solid line in FIG. 2) and an extended position (as shown in broken line in FIG. 2). Each winch cable 26 is operable for powered movement between the retracted and extended positions to assist positioning of the patient's body. For example, as shown in FIG. 2, a leg sling 54 supports the patient's right leg and is attached with one of the winch cables 26 for selective movement, and a trapeze handle 56 is attached with the other of the winch cables 26 for grasping by the patient.

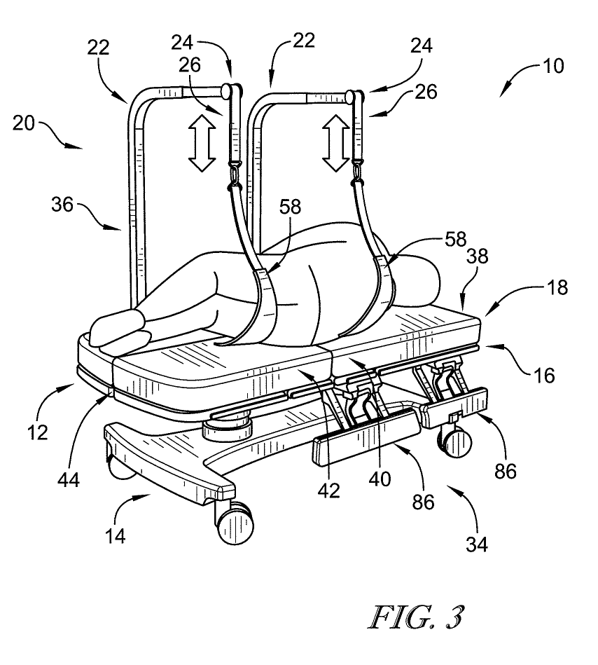

In FIG. 3, each of the support sections 38-44 have been articulated into a flat position. Each of the positioning arms 22 have illustratively been pivoted to be arranged along the same lateral side 36 of the support top 12. Each winch cable 26 is illustratively attached with a turn sling 58 to assist turning of the patient on the support top 12.

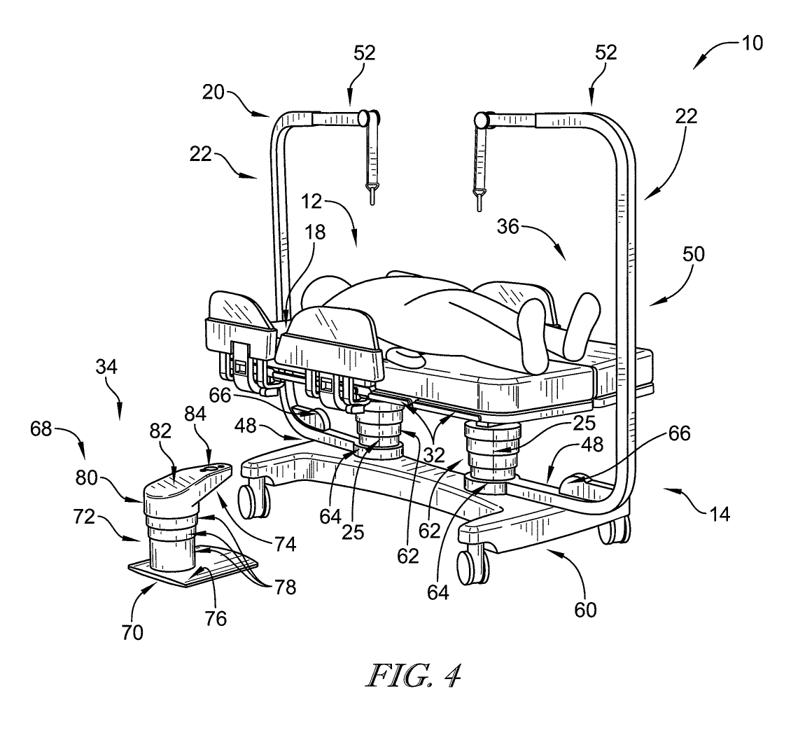

As shown in FIG. 4, the frame 14 illustratively includes a base 60 and support columns 62 extending vertically from the base 60 for engagement with the support top 12 to provide support thereto. The base 60 illustratively includes wheels, but in some embodiments, may include an suitable arrangement for engagement with the floor. The columns 62 are illustratively embodied as telescoping columns positionable between retracted and extended positions to provide selective height adjustment of the support top 12.

As best shown in FIG. 4, each positioning arm 22 is illustratively secured with one of the columns 62. The positioning arms 22 each illustratively include a collar 64 attached to the respective branch 48. The collar 64 illustratively includes an annular shape disposed about the respective column 62. The collars 64 each illustratively connect with the frame 14 for pivotable movement about a pivot axis 25 as shown in FIG. 4. In the illustrative embodiment, the pivot axes 25 are the central axes of the respective support columns 62, but in some embodiments, the pivot axes 25 may be defined independently from the support columns 62.

As best shown in FIG. 4, a winch assembly 66 is attached to each positioning arm 22. In the illustrative embodiment, each winch assembly 66 includes a motor, cable spool including the winch cable 26, and transmission members for selectively rotating the spool to retract and extend the winch cable 26. The winch assemblies 66 provide suspension load applied from the end 24 of the positioning arms 22. In some embodiments, any suitable mechanism for assisting positioning of the patient's body, for example but without limitation, control arms.

As shown in FIG. 4, the patient support system 10 illustratively includes a base 68 for selective engagement with the support top 12. The base 68 is illustratively embodied as a surgical base that can selectively replace the frame 14 to support the support top 12 above the floor. The base 68 is illustratively embodied to telescope from the floor to provide selective height adjustment.

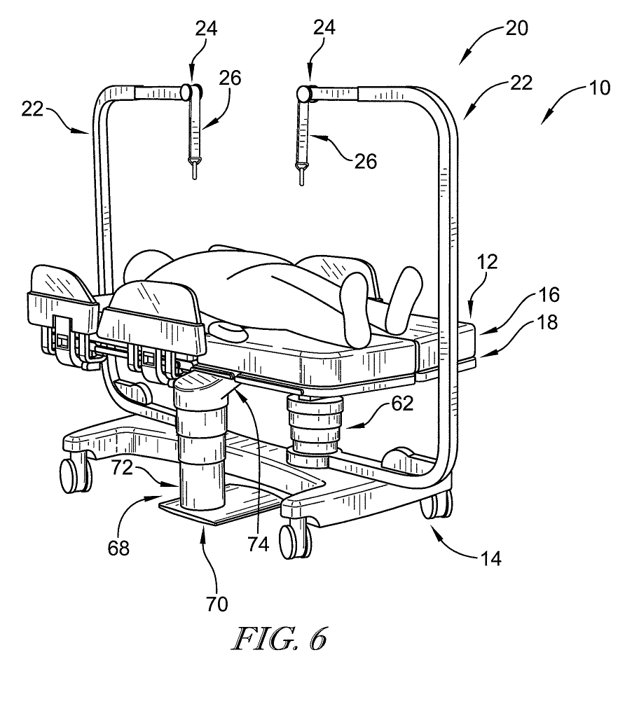

As shown in FIG. 4, the base 68 illustratively includes a foot 70 engaged with the floor, a column 72 connected with the foot 70 and extending vertically therefrom, and an attachment arm 74 extending from the column 72 and adapted for selective attachment with the support top 12. The foot 70 illustratively includes a plate 76 engaged with the floor. The column 72 is illustratively secured with the plate 76 and includes a series of coaxial column sections 78 arranged for telescoping. As mentioned above, the column 72 is illustratively extendable between a retracted position (as best shown in FIG. 4) and an extended position (as best shown in FIG. 6).

As shown in FIG. 4, the attachment arm 74 is illustratively secured to an end of the column 72 opposite the foot 70. The attachment arm 74 illustratively includes a cap 80 connected with the column 72 and forming a final telescoping section and a limb 82 extending laterally and slightly vertically from the cap 80 to form a receiver 84 for engagement with the support top 12. The receiver 84 selectively engages with the support top 12 to providing support thereto.

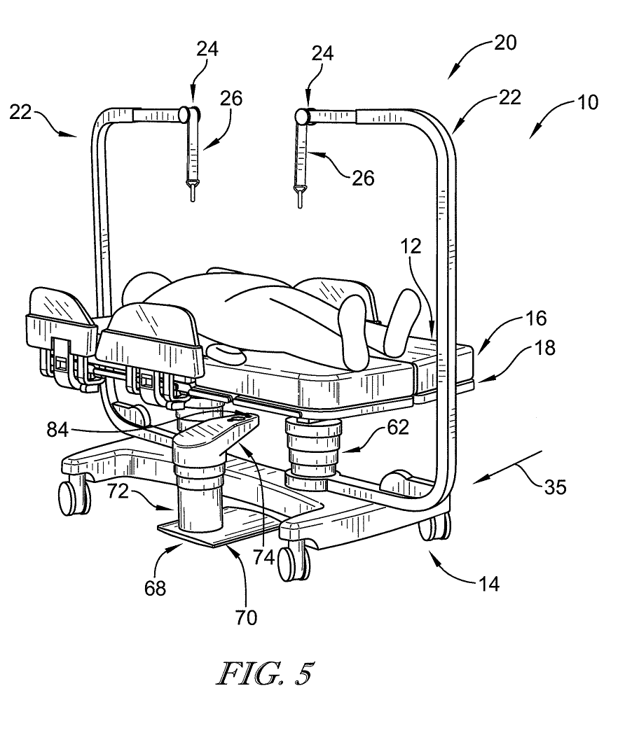

As shown in FIG. 5, the support top 12 is illustratively positioned over the base 68 to prepare for transfer between the frame 14 and the base 68. The frame 14 with the support top 12 still attached is moved into position as indicated by the arrow 35 such that the base 68 is below the support top 12 near its point of engagement with the base 68. The support top 12 illustrative includes a locating feature for guiding the position of the support top 12 relative to the base 68. The locating feature is embodied to include rails projecting towards the floor from the bottom of the platform 16 and leading the receiver 84 to correspond with the connection point with the support platform 16.

As shown in FIG. 6, the base 68 is selectively operated to connect with the support top 12. In the illustrative embodiment, the base 68 is operated into an extended position to engage the receiver 84 with the support top 12. Upon safe connection of the base 68 with the support top 12, the frame 14 is illustratively disengaged with the support top 12. In the illustrative embodiment, the base 68 is engaged with the support top 12 at an intermediate extension position while the connection of the frame 14 with the support top 12 is unlocked. The base 68 is illustratively operated into the extended position (as shown in FIG. 6) to remove the support top 12 from connection with the support columns 62 of the frame 14. In some emnbodiments, the support top 12 may be slidingly disengaged from the frame 14. The support top 12 is selectively transferred to the base 68 for support above the floor.

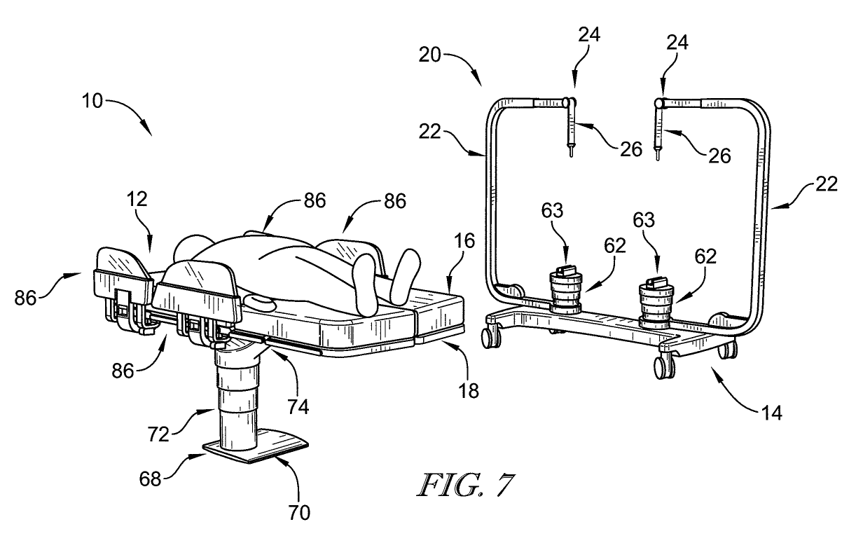

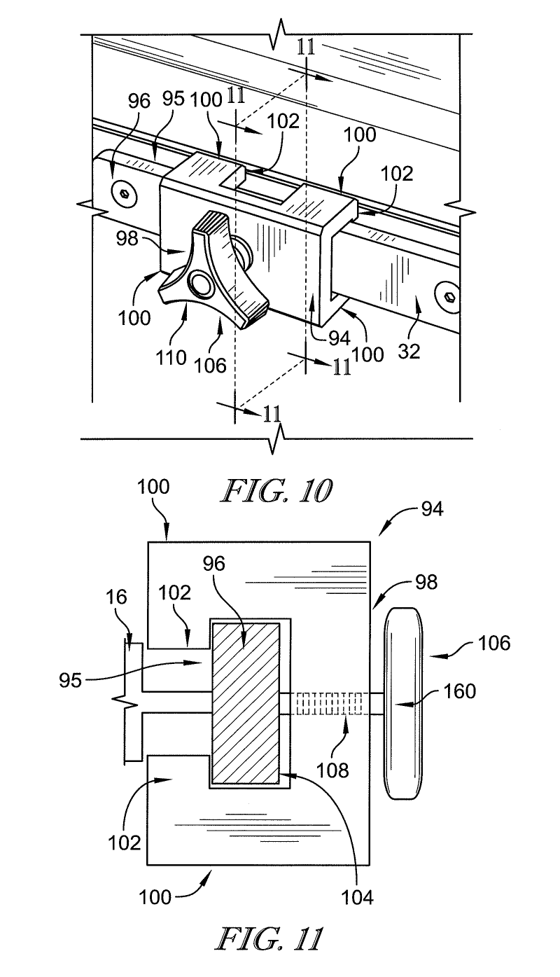

As shown in the illustrative embodiment shown in FIG. 7, the support top 12 being supported above the floor by the base 68, the frame 14 can be moved away from the support top 12. In FIG. 7, couplers 63, configured as channel members that receive mating portions of the platform 16, in the illustrative embodiment, are situated atop the support columns 62. In some embodiments, the mating portions of the platform 16 are frame members similar to attachment rails 32 although such frame members are located on the underside of the platform 16. Suitable locks such as thumbscrews, latches, pins, clamps, or the like are included in couplers 63 in some embodiments and are movable between locking positions to secure the platform 16 in place on the columns 63 and releasing positions to permit the platform 16 to be detached from columns 63 via movement in a lateral direction of the support top 12. The description of the structures of FIGS. 10-14, therefore, provides examples of some suitable locks that are included in couplers 63 in some embodiments. As shown in FIG. 7, the support top 12 is illustratively arranged for specific use, for example, as a surgical support during surgery and/or other treatment, diagnostic, and/or therapy procedures. Removal of the frame 14 and positioning system 20 from the support top 12 provides less encumbered access to the patient without requiring patient transfer between different support tops.

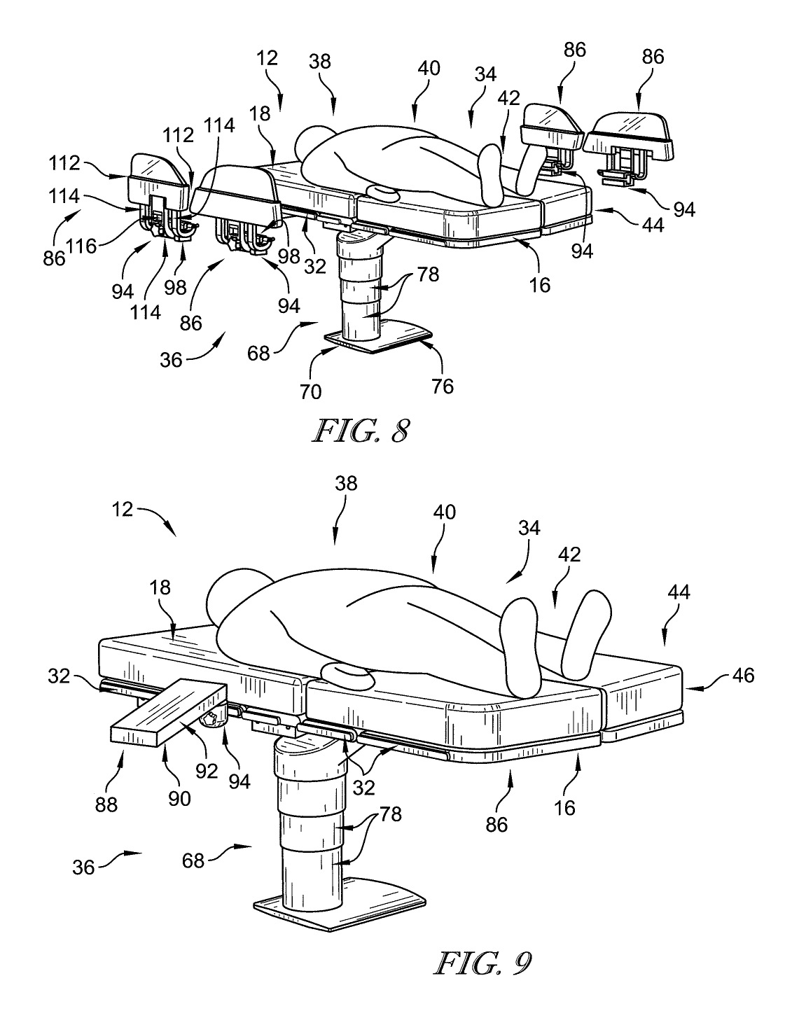

As shown in FIGS. 6-8, side rails 86 are illustratively removably attached with the support top 12. The side rails 86 can remain attached with the support top 12 while supported by either of the frame 14 or the base 68. As shown in FIG. 8, the side rails 86 are detached from the support top 12. Detachability of the side rails 86 promotes access to patients occupying the support top 12 and promotes multi-use configuration of the support top 12. In the illustrative embodiment, the side rails 86 are removably attached to the attachment rails 32.

As shown in FIG. 9, an attachment device 88, illustratively embodied as a limb support board 90 is secured to the attachment rail 32. The limb support board 90 illustratively provides a distinctly positionable support surface to support patient limbs, for example, arms, in selective positions to accommodate access to the patient's body. The limb support board 90 illustratively includes a limb support 92 and an attachment clamp 94 extending from the limb support 92 for connection with the attachment rail 32.

As shown in FIG. 9, the limb support 92 is illustratively connected with the attachment clamp 94 by a selectively articulable connection to permit a range of selective positioning relative thereto. In some embodiments, the limb support board 90 may include an multi-axis adjustable system for connecting the attachment clamp 94 with the limb support 92, for example but without limitation, as shown and described in U.S. Pat. No. 8,322,342, the contents of which are incorporated by reference in their entirety, and at least those portions directed to multi-axis adjustability of limb supports. In the illustrative embodiment as shown in FIGS. 8 and 9, each of the side rails 86 and the attachment device 88 are removably attachable with the support top 12 via the attachment rails 32.

As shown in FIG. 10, the attachment clamp 94 is shown in additional detail secured to the attachment rail 32. The attachment rail 32 illustratively includes a rail body 96 secured to the platform 16 with spaced apart arrangement (shown in FIG. 10) to define a gap 95 therebetween. Each attachment clamp 94 illustratively includes a clamp body 98 and arms 100 extending from the clamp body 98 to form fingers 102 to wrap around the rail body 96. The arms 100 and fingers 102 define a slot 104 for receiving the rail body 96 such that the fingers 102 are arranged within the gap 95. The attachment clamp 94 includes a tensioner 106 for locking the clamp body 98 with the attachment rail 32.

As shown in FIG. 10, the tensioner 106 illustratively includes a rod 108 penetrating through the clamp body 98 to engage the attachment rail 32 within the slot 104. The rod 108 illustratively included external threads for engagement with internal threads of the clamp body 98 and a knob 110 for operation to rotate the rod 108 within the clamp body 98 to set the amount of extension of the rod 108 into the slot 104. Engagement of the rod 108 with the rail body 96 secures the arms 100 against the rail body 96 to selectively connect the attachment clamp 94 with the attachment rail 32. Rotating the knob 110 to retract the rod 108 from engagement with the rail body 96 illustratively releases the attachment clamp 94 from the attachment rail 32 allowing repositioning and/or removal of the attachment clamp 94. The attachment rails 32 and attachment clamps 94 form an attachment assembly for securing a suite of attachments with the support top 12.

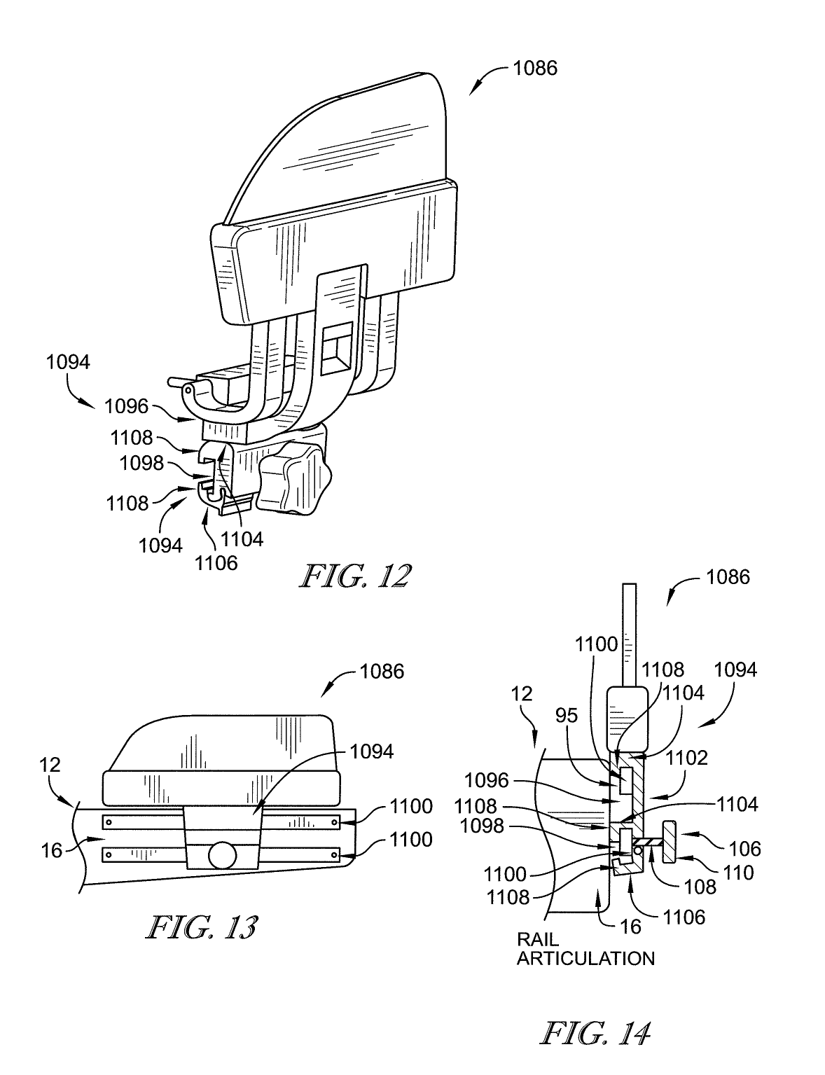

As shown in FIGS. 12-14, another illustrative attachment assembly includes an attachment clamp 1094. Referring to FIG. 12, as an example, the attachment clamp 1094 is shown as a portion of another side rail 1086, but may be applied to the attachment device 88 and any of a suite of attachments devices. As shown in FIG. 13, attachment clamp 1094 illustratively includes an upper slot 1096, and a lower slot 1098 each arranged to receive a respective rail body 1100 for connection with the support top 12.

As shown in FIG. 13, the rail bodies 1100 are illustratively attached to the lateral sides of the platform 16 parallel to each other with predetermined spacing from each other. Each rail body 1100 is illustratively embodied similar to the rail body 96 having a gap 95 between itself and the platform 16.

As best shown in FIG. 14, the attachment clamp 1094 illustratively includes a clamp body 1102 and arms 1104, 1106 extending from the clamp body 1102 for engagement with the respective rail bodies 1100. Each arm 1104, 1106 illustratively includes a finger 1108 for arrangement within the gap 95 between the respective rail body 1100 and the platform 16. The attachment clamp 1094 illustratively includes a tensioner 106 for adjustable engagement with the lower rail body 1100 as described relative to the attachment clamp 94 above.

As shown in FIG. 14, the arm 1106 is illustratively formed as a movable arm having a hinged connection with the clamp body 1102. Engagement of the rod 108 of the tensioner 106 with the lower rail body 1100 secures the arm 1106 in a closed position engaged with the lower rail body 1100. Release of the rod 108 from engaging the lower rail body 1100 allows the arm 1106 to swing to an open position to permit repositioning and/or removal of the attachment claim 1094 from the support top 12. The hinged connection permits the attachment clamp 1094 to be engaged with the rail bodies 1100 and then secured in place by the tensioner 106.

Connection with the dual attachment rails and clamps provides a levered connection with mechanical advantage to distribute forces. Accordingly, a suite of attachments can be selectively connected with the patient support 12. In some embodiments, the attachment clamp 94 may be attachable with at least one of the upper and/or lower rail bodies 1100.

Referring to FIG. 1, side rails 86 are connected with the platform 16 and adapted for selective articulation between a raised position (as shown in FIG. 1) and a lowered position (as shown in FIG. 3). Referring to FIG. 8, a siderail body 112 includes a number of arms 114 that are pivotably secured with the clamp body 98. A latch mechanism 116 maintains the current raised or lowered position until operate for release by a user.

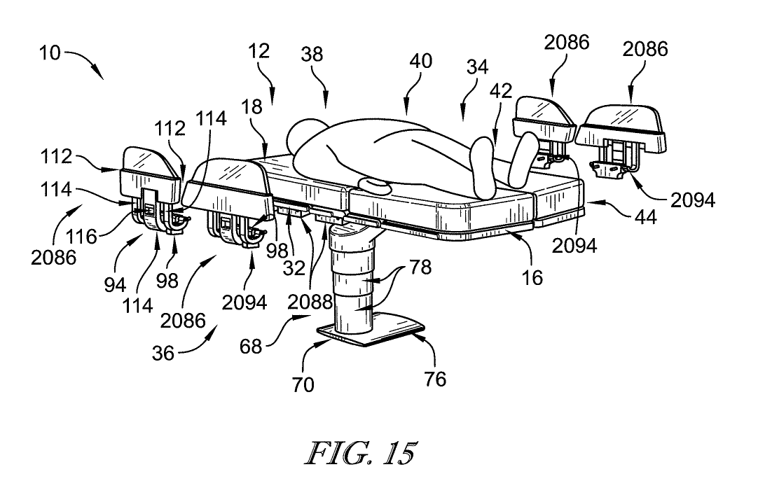

As shown in FIG. 15, the patient support system 10 is shown to includes another illustrative attachment embodied as side rails 2086. The side rails 2086 are illustratively similar to side rails 86, 1086 as shown and described above, except where it would conflict with the specific description and illustration of side rails 2086. In the illustrative embodiment, the side rails 2086 each include an attachment seat 2094 for selective attachment with the platform 16 by a dedicated receiver 2088, distinct from the attachment rails 32. The receiver 2088 is illustratively secured to the underside of the platform 16 and is complimentary to receive releasable connection with the attachment seat 2094. In some embodiments, the side rails 2086 may be used alone or together with one or more of the side rails 86, 1086.

Although certain illustrative embodiments have been described in detail above, variations and modifications exist within the scope and spirit of this disclosure as described and as defined in the following claims.

1. A patient support system comprising
a support top including a platform and a support surface positioned on a top side of the platform,
a support frame coupled to the support top, the support frame including a number of support columns extending vertically for connection with the support top, and
at least one positioning arm for assisting movement of a patient's body occupying the support top, the at least one positioning arm extending from one of the number of support columns to an operation end located above the support top,
wherein the at least one positioning arm is pivotable about the one of the number of support columns for positioning the operation end relative to the patient's body.

2. The patient support system of claim 1, wherein the at least one positioning arm includes a collar extending at least partially circumferentially about the one of the number of support columns.

3. The patient support system of claim 1, wherein the at least one positioning arm includes a branch extending from the one of the number of support columns to an end that is spaced apart laterally from an edge of the support top and a riser projecting upward from the branch to an end that is above the support top.

4. The patient support system of claim 3, wherein the at least one positioning arm includes a limb extending from the riser to form the operation end.

5. The patient support system of claim 4, wherein the branch and the limb extend parallel to each other.

6. The patient support system of claim 1, wherein the support frame includes a base for engagement with the floor and the number of support columns extends vertically from the base for connection with the support top.

7. The patient support system of claim 6, wherein the number of support columns connects with a bottom side of the platform.

8. The patient support system of claim 1, wherein the support top includes at least one attachment rail arranged on a lateral side of the support top.

9. The patient support system of claim 1, wherein the at least one attachment rail includes a rail body extending between head and foot ends of the support top and attached to the platform for receiving connection of auxiliaries.

10. The patient support system of claim 9, furthering comprising a number of limb support boards and a number of siderails each configured for selective removable attachment to the rail body of the attachment rail.

11. The patient support system of claim 10, wherein the number of siderails are attached to the rail body and adapted for selective articulation between a raised position in which a siderail body is arranged above the support top and a lowered position in which the siderail body is arranged below the support top.

12. A patient support system comprising
a support device including a support top having a support surface and a platform having at least one attachment rail, and at least one support column for supporting the support top above the floor,
a positioning system including at least one positioning arm extending from the support device and adapted to assist positioning a patient's body occupying the support top, and
an auxiliary attachment suite for removable attachment to the support device, the auxiliary attachment suite including a number of siderails and a number of attachment devices each configured for removable attachment with the at least one attachment rail of the platform.

13. The patient support system of claim 12, wherein at least one positioning arm extends from one of the number of support columns to an operation end located above the support top.

14. The patient support system of claim 13, wherein the at least one positioning arm includes a collar extending at least partially circumferentially about the at least one support column.

15. The patient support system of claim 13, wherein the at least one positioning arm includes a branch extending from the one of the number of support columns to an end that is spaced apart laterally from an edge of the support top, a riser projecting upward from the branch to an end that is above the support top, and a limb extending from the riser to form the operation end.

16. The patient support system of claim 12, wherein the at least one attachment rail is arranged on a side of the support top.

17. The patient support system of claim 16, wherein the at least one attachment rail includes a rail body extending between head and foot ends of the support top and attached to the platform for receiving selective connection with the auxiliary attachment suite.

18. The patient support system of claim 12, wherein the number of siderails are each removably attached to the rail body and adapted for selective articulation between a raised position in which a siderail body is arranged above the support top to inhibit the patient's body from exiting the support top and a lowered position in which the siderail body is arranged below the support top.

19. The patient support system of claim 12, wherein the number of side rails each include an attachment clamp for removable attachment to the at least one attachment rail.

20. The patient support system of claim 19, wherein the attachment clamp including a clamp body and at least one arm pivotably attached to the body.

21. The patient support system of claim 12, wherein the at least one attachment rail includes two attachment rails attached to one side of the support platform, and the number of side rails each include an attachment clamp including a clamp body and at least one arm extending from the body for engagement with one of the two attachment rails and at least one other arm extending from the body for engagement with another of the two attachment rails.
